(19) United States
(12) Patent Application Publication
(10) Pub. No.: US 2005/0169816 A1
(43) Pub. Date: Aug. 4, 2005

(54) Automated oligomer synthesis

(76) Inventor: Brian M. Kirshner, Foster City, CA (US)

Correspondence Address: KOLISCH HARTWELL, P.C., 520 S.W. YAMHILL STREET, SUITE 200, PORTLAND, OR, 97204, US

(21) Appl. No.: 11/013,940

(22) Filed: Dec. 15, 2004

Related U.S. Application Data
(60) Provisional application No. 60/530,105, filed on Dec. 15, 2003.

(51) Int. Cl. B01J 19/00

(52) U.S. Cl. 422/130

(57) ABSTRACT

Systems, including apparatus and methods, for automated synthesis of oligomers.

### CROSS-REFERENCES TO PRIORITY APPLICATION

This application is based upon and claims the benefit under 35 U.S.C. § 119(e) of U.S. Provisional Patent Application Ser. No. 60/530,105, filed Dec. 15, 2003, which is incorporated herein by reference in its entirety for all purposes.

### INTRODUCTION

Oligomers are chemical compounds, such as oligonucleotides or peptides, that include a covalently linked array of individual subunits. The identity of each individual subunit and the arrangement of the individual subunits within the array generally define the chemical and biological properties of each oligomer. In particular, a small change in the chemical structure of an oligomer, such as a single nucleotide change in an oligonucleotide, can impart quite distinct biological properties to the oligomer. Accordingly, large numbers of different oligomers are produced by custom synthesis for various clinical and research applications. Such custom synthesis can benefit from increased efficiency.

### SUMMARY

The present teachings provide systems, including apparatus and methods, for automated synthesis of oligomers.

### BRIEF DESCRIPTION OF THE DRAWINGS

FIG. 1 is a schematic view of a system for automated synthesis of oligomers, in accordance with the present teachings.

FIG. 2 is a schematic view of an exemplary conveyor for an automated synthesis system, in accordance with the present teachings.

FIG. 3 is a schematic view of another exemplary conveyor for an automated synthesis system, in accordance with the present teachings.

FIG. 4 is a schematic view of selected aspects of the system of FIG. 1, particularly an exemplary synthesis station thereof, in accordance with the present teachings.

FIG. 5 is a schematic partially sectional view of selected aspects of the synthesis station of FIG. 4, particularly a reagent reservoir, and a sensor and refill reservoir connected to the reagent reservoir, in accordance with the present teachings.

FIG. 6 is a schematic view of another exemplary synthesis station of a system for automated oligomer synthesis, in accordance with the present teachings.

FIG. 7 is a schematic view of yet another exemplary synthesis station of a system for automated oligomer synthesis, in accordance with the present teachings.

FIG. 8 is a partially schematic view of selected aspects of a system for automated synthesis, particularly a conveyor, conveyor-associated sensors, and a processor, in accordance with the present teachings.

FIGS. 9A-9E are schematic views illustrating an exemplary reaction progression for automated oligomer synthesis, in accordance with the present teachings.

FIGS. 10A-10C are schematic views illustrating another exemplary reaction progression for automated oligomer synthesis, in accordance with the present teachings.

FIG. 11A-11B are schematic views illustrating yet another exemplary reaction progression for automated oligomer synthesis, in accordance with the present teachings.

### DESCRIPTION OF VARIOUS EMBODIMENTS

The present teachings provide a system, including apparatus and methods, for automated synthesis of oligomers. The system can include a synthesis station, a conveyor device, and/or a controller, among others. The synthesis station can include a dispenser for dispensing reagents to reaction vessels disposed in synthesis sites of the synthesis station. The synthesis station also can include a fluid removal mechanism for removing, from the reaction vessels, at least a portion of the dispensed reagents. The conveyor device can include a plurality of re-usable receivers or holders that are driven along a closed loop. The receivers thus can receive and support reaction vessels as the reaction vessels are moved through the synthesis station, from an entrance to an exit of the station. The controller can receive data defining a sequence of subunits for one or more oligomers to be synthesized in each reaction vessel. The controller also can control operation of the dispenser and the conveyor device so that the dispenser dispenses the reagents to each reaction vessel according to the one or more oligomers defined for the reaction vessel and also according to one or more of the synthesis sites in which the reaction vessel is placed by the conveyor device during synthesis of the oligomers.

In some embodiments, the system can be configured to perform synthesis of oligomers in the synthesis station using an asynchronous (or staggered) approach. Such an asynchronous approach, in contrast to a synchronous or batch approach, can involve starting temporally overlapping syntheses of oligomers in different reaction vessels at different times in the synthesis station. Accordingly, at a given time, the synthesis station can hold reaction vessels with oligomers in various stages of completion. Furthermore, each oligomer can be synthesized completely with its corresponding reaction vessel disposed in only one position in the synthesis station, or by partial synthesis of the oligomer in each of two or more positions in the synthesis station. The positions can be predefined positions, for example, predefined positions at which the conveyor device stops, or dynamic positions defined during movement of the conveyor device. As oligomers are completed, their corresponding reaction vessels can be removed from the synthesis station to make space for new reaction vessels on the conveyor device.

This asynchronous or “continuous” approach can have advantages over the batch approach. For example, the system can achieve a higher throughput of synthesized oligomers than with a batch approach, because, for example, completed oligomers can be removed more quickly from the synthesis station than with the batch approach. In addition, this asynchronous approach can provide an earlier time of starting and completion for higher priority (“rush”) oligomers, because, for example, these rush oligomers can be started as soon as space becomes available in the synthesis station, rather than waiting until an entire batch of oligomers is completed. Furthermore, the automated synthesis described herein, whether batch or asynchronous, can synthesize oligomers with a lower cost, a higher quality, a higher throughput, and/or in a shorter time than other synthesis systems.

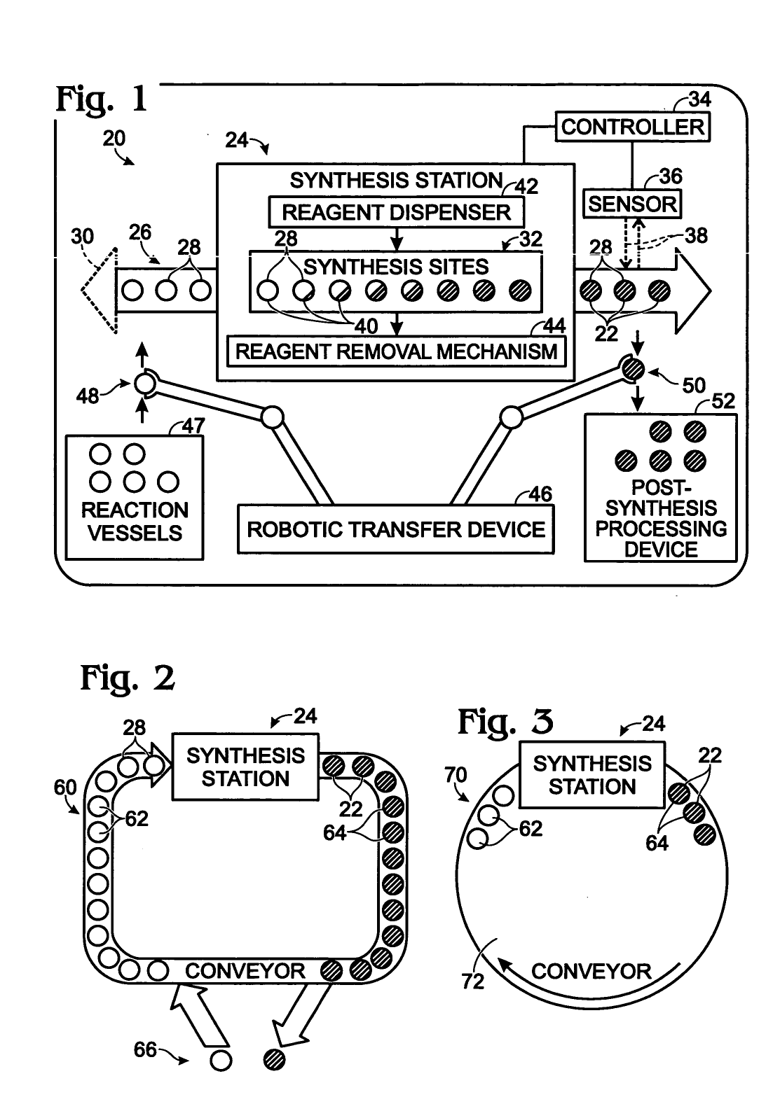

FIG. 1 shows a system 20 for automated synthesis of oligomers 22 (shown as hatched regions). System 20 can include a synthesis station 24 at which oligomers are synthesized, and a conveyor 26 that moves reaction vessels 28 into and out of the synthesis station. Conveyor 26 can move reaction vessels 28 in one direction (uni-directionally) through the synthesis station, or in two directions (bi-directionally), shown at 30, among others.

In the present illustration, and elsewhere in the figures, reaction vessels are shown as unhatched before oligomer synthesis, partially hatched during oligomer synthesis, and fully hatched after completion of oligomer synthesis (addition of subunits is complete, but not necessarily additional processing, such as cleavage and/or deprotection, among others). In the present illustration, a set of new reaction vessels waiting to enter the synthesis station is disposed to the left of the synthesis station on the conveyor. The reaction vessels can be equivalent or different, for example, by carrying different oligomer subunits that will form the initial subunits of new oligomers. In addition, reaction vessels with completed oligomers that have exited the synthesis station are disposed to the right of the synthesis station on the conveyor. The synthesis station in this example holds eight reaction vessels, indicated at 32, including a new reaction vessel without an oligomer on the far left of the station, a reaction vessel with a completed oligomer on the far right of the station, and reaction vessels with oligomers at various stages of completion (and thus different amounts of hatching) intermediate to the reaction vessels on the far left and far right of the station. More generally, sets of any suitable numbers of new and/or completed reactions may be disposed at any suitable positions or orientation relative to the synthesis station.

System 20 further can include a controller 34 (or processor). The controller can control and coordinate the operation of various portions of the system, such as the synthesis station 24 and the conveyor 26. The controller also can be in communication with a sensor 36 that senses one or more aspects of the system, shown at 38.

The synthesis station can include various structures and mechanisms for conducting synthesis. The synthesis station can define a set of receiving or synthesis sites 40 at which reaction vessels 28 can be positioned during oligomer synthesis. The synthesis station can include a reagent dispenser 42 for dispensing reagents to the reaction vessels positioned in the synthesis sites. In addition, the synthesis station can include a fluid removal mechanism 44 for removing at least a portion of the dispensed oligomer reagents (including reacted derivatives thereof) from the reaction vessels. The dispenser and/or fluid removal mechanism can be configured to operate on reaction vessels that are moving and/or stopped. In some examples, adding and removing fluid from moving reaction vessels can substantially decrease the time for each oligomer synthesis and thus substantially increase the oligomer output of the synthesis system.

System 20 further can include a robotic transfer device 46. Transfer device 46 can be configured to add unreacted reaction vessels to conveyor 26 from a storage region 47 before synthesis begins, shown at 48. Alternatively, or in addition, transfer device 46 can be configured to remove reaction vessels with completed oligomers from the conveyor, shown at 50. These reaction vessels with completed oligomers can be placed in a post-synthesis processing device 52 configured to provide further oligomer processing, for example, structural modification of oligomers (such as deprotection) and/or uncoupling/removal of the oligomers from the reaction vessels. Reaction vessels can be moved to post-synthesis processing devices by the conveyor itself and/or by one or more robotic transfer devices.

Further aspects of the present teachings are described in the following sections, including (I) synthesis stations, (II) conveyors, (III) reaction vessels, (IV) controllers, (V) sensors, (VI) robotic transfer devices, (VII) post-synthesis processing devices, (VIII) reaction progressions, and (IX) examples.

I. Synthesis Stations

The synthesis system includes at least one synthesis station. A synthesis station is a region (or regions) of the system in which reaction vessels are positioned, reagents are dispensed, reagents are removed, and/or oligomers are created.

In some examples, the synthesis station can be configured as a series of sub-stations. Each sub-station can be configured to add a single reagent, a single subunit, multiple subunits, etc. Accordingly, in some embodiments, the number of sub-stations can define the maximum length of an oligomer synthesized. Alternatively, the systems of the present teachings can be configured to permit reaction vessels to pass through a sub-station two or more times, or to remain in a sub-station for addition of two or more subunits, so that any number of subunits can be added by each sub-station. The sub-stations can be arrayed in any suitable arrangement, including linear, arcuate, serpentine, etc. In some examples, arrangement of the sub-stations along a folded or serpentine path, rather than a generally linear path, can permit a larger number of sub-stations to be disposed in a more compact configuration.

Further aspects of synthesis stations are including in the following subsections, including (A) synthesis sites, (B) reagent dispensers, (C) reagents and oligomers, and (D) fluid removal mechanisms.

A. Synthesis Sites

The synthesis station includes synthesis sites at which reaction vessels can be positioned to receive reagents from the reagent dispensers. The synthesis sites can be defined by the target area of the reagent dispenser and/or by the path of the conveyor, among others.

The synthesis sites can be present in any suitable number and arrangement. The synthesis station can include a plurality of synthesis sites or one synthesis site. The synthesis sites can be arranged in single file, such as in a linear or nonlinear array (e.g., an arcuate array). Alternatively, or in addition, the synthesis sites can be arranged in a two-dimensional array, such as a rectilinear array, among others, or in a three-dimensional array, such as with tiers of two-dimensional arrays of synthesis sites.

Each synthesis site can be disposed at a predefined, discrete position, at a position within a continuous range of positions, and/or may be defined dynamically, such as when reagents are delivered to moving reaction vessels. A predefined, discrete position for a synthesis site can correspond to a discrete position at which a conveyor places reaction vessels. Alternatively, or in addition, the predefined, discrete position can correspond to a discrete position at which a reagent dispenser is positioned to dispense reagents. A continuous set of synthesis sites can correspond to a continuous range of positions at which a conveyor can place reaction vessels and/or at which a reagent dispenser can dispense reagents.

The synthesis station can provide a reaction compartment in which the synthesis sites are disposed. The reaction compartment can be a substantially enclosed chamber (or set of chambers) or an unenclosed region of the synthesis system. In either case, the synthesis station can be configured to regulate reaction conditions at the synthesis sites. Exemplary reaction conditions that can be regulated include humidity, reagent moisture content, temperature, pressure, electromagnetic radiation exposure (such as exposure to light), atmosphere (such as gas composition and/or oxygen content), and/or the like. In some examples, one or more of the reaction conditions can be controlled by signals sent by the controller to the synthesis station, such as actuation signals sent to one or more regulatory devices of the synthesis (e.g., heaters, lights, pumps, valves, etc.).

B. Reagent Dispensers

The synthesis station can include one or more reagent dispensers configured to dispense reagents to reaction vessels. A reagent dispenser can include a dispense head, reagent reservoirs, conduits, valves, automated pipettors, and/or pumps, among others. The reagent dispenser can dispense reagents using contact and/or noncontact mechanisms.

Each reagent dispenser can dispense reagents to the synthesis sites from one or more dispense heads, each having one or more dispense structures (such as dispense tips, among others), which release fluid to reaction vessels from the dispenser. The dispense structures of a dispense head can be fixed and/or movable in relation to the synthesis sites. If fixed in relation to the synthesis sites, the conveyor can be configured to move reaction vessels in relation to the dispense structures (or structure), for example, back and forth into receiving relation with suitable dispense structures during oligomer synthesis. If movable in relation to the synthesis sites, each dispense structure can be configured to be movable for dispensing to each of the synthesis sites, or to a subset of the sites. The dispense structures can be configured to move horizontally and/or vertically. Horizontal movement can be generally parallel to a path followed by reaction vessels within the synthesis station, for example, to permit the dispenser to access and dispense reagents to different reaction vessels and/or to dispense different reagents to the same reaction vessel. Alternatively, or in addition, horizontal movement may be transverse to the path followed by reaction vessels within the synthesis station, for example, to permit the dispenser to selectively dispense different reagents (such as different subunit reagents to the same synthesis site, and/or to access reaction vessels disposed in a planar array. Vertical movement of the dispense structures can permit the separation of the dispense structures and the reaction vessels to be adjusted and/or to permit the dispense structures to reach individual reaction vessels arrayed vertically, among others.

The dispense structures can fixed or movable within a dispense head. In some embodiments, the systems described herein can include two or more dispense heads that are movable independently. Such dispense heads can be configured to dispense the same reagents as each other (redundant dispense heads) or different reagents. For example, each synthesis sub-station can have a distinct dispense head (or heads), to enable independent addition of one or more oligomer subunits by each sub-station. If the same or overlapping sets of reagents are dispensed by two or more dispense heads, corresponding dispense structures of the dispense heads can be connected to the same reagent reservoir or different reservoirs. The use of two or more dispense heads (and/or the use of two or more dispense tips per dispense head) can increase synthesis throughput. Dispensing fluid from two or more heads and/or tips may be synchronous and/or asynchronous. Furthermore, volumes of fluid dispensed from each head and/or tip may be with fixed and/or dynamically adjustable (such as with a feedback loop to incrementally increase (or decrease) the dispensed volume to improve oligomer yield and/or quality).

Any suitable number of reagents can be stored in reagent reservoirs disposed in fluid communication with the dispense structures. The dispense structures can be connected in one-to one correspondence with a set of reagent reservoirs. Alternatively, different reagent reservoirs can be in communication with the same dispense structure, to provide, for example, mixed and/or alternate dispensing of reagents from the different reagent reservoirs.

Reagent reservoirs can be configured to be replenished with reagents during operation of the reagent dispenser and/or when the reagent dispenser is inactive. In some examples, the reagent reservoirs can include a refill site at which additional reagent can be added. Alternatively, or in addition, a dispenser can include two or more reagent reservoirs for a reagent, so that one of the reagent reservoirs can be refilled off-line while another of the reagent reservoirs is supplying reagent to a dispense structure. Alternatively, or in addition, a reagent can be replenished with the reagent reservoir off-line by replacing a depleted reagent reservoir with a replacement reservoir holding the reagent.

Reagent reservoirs and/or other structures of the dispenser can be coupled to sensors configured to sense an absolute and/or relative condition of the reagents (such as identity, concentration, amount, purity, turbidity, temperature, pressure, viscosity, pH, ionic strength, water concentration, etc.), rate of reagent dispensing, amount of reagent dispensed, etc. Sensors are described below in more detail in Section V.

The reagent dispenser can include conduits, valves, and/or a pump to propel, guide, and/or restrict movement of reagents between the reagent reservoirs and the dispense structures. The conduits can define parallel paths between the reagent reservoirs and the dispense structure. Alternatively, or in addition, the conduits can define a branched network so that the same reagent reservoir can connect to a plurality of dispense structures and/or so that a plurality of reagent reservoirs can connect to the same dispense structure. The valves (or one valve) can open and close the conduits and can be operable manually and/or through a controller. The open time for a valve can define the volume of reagent dispensed to a reaction vessel. However, in some examples, the reagent dispenser does not have valves disposed between pumps and dispense tips. Instead, operation of the pump, rather than operation of a valve, adjustably can determine the timing and/or volume of fluid dispensed. The pump (or pumps) can be any mechanism that propels reagents from the reagent reservoirs to the dispense structures and/or that expels reagents from the dispense structures. The pump can exert a pressure on reagents directly or on a compartment in fluid communication with the reagents. The pump can act to push and/or pull reagents during dispensing (e.g., by creating positive relative pressure within a dispense tip to push reagents out, by creating a negative relative pressure outside the dispense tip to pull reagents out, among others). Accordingly, the pump can be a positive-displacement pump (e.g., a syringe pump, a peristaltic pump, a rotary pump, rotating/reciprocating piston pump, etc.), an automated pipettor, a vacuum pump, pressurized gas, a partial vacuum, and/or the like. In some embodiments, the gas (such as nitrogen, argon, among others) provided by the pump places reagents under a more inert environment, such as by reducing exposure to moisture, oxygen, etc. The pump(s) can be configured to dispense an adjustable volume of fluid for different reagents (such as different subunit reagents), synthesis steps, oligomers (e.g., for different scales of synthesis), etc. For example, the volume may be adjustable over time based on reaction yield and/or quality (such as in a feedback loop).

In some embodiments, the pump(s) can be a reversible flow pump(s). The reversible flow pump can be configured to push fluid forward from a pump head, along a charge line (conduit), to a dispense tip. The reversible flow pump also can be configured to pull fluid back from the dispense tip and the charge line, for example, using a “suck back” mechanism. Pulling fluid back from the dispense tip and charge line, and into the pump head, can reduce the amount of evaporation that occurs from the charge line out of the dispense tip, prior to the next dispensing of fluid from the dispense tip. Minimizing evaporative loss by this mechanism can reduce undesired variability in fluid dispensing, to produce more reproducible dispensed volumes and thus more consistent oligomer quality. Evaporative loss from dispense tips can be more problematic with volatile solvents (such as those often used in oligomer synthesis), and can be quite variable, particularly with variable and/or more extended times between uses of the dispense tips. For example, particular dispense tips can be used less frequently, such as tips dedicated to synthesis of oligomers longer than the average synthesized length (and sometimes located at more downstream positions in the synthesis station) and/or configured to dispense more specialized reagents, among others.

C. Reagents and Oligomers

The reagent dispenser can dispense any suitable reagents for synthesis of oligomers. Such reagents, generally termed oligomer reagents, can include oligomer components and ancillary reagents.

Oligomer components generally include any chemical compounds that are partially or completely incorporated into oligomers during their synthesis, generally through covalent linkage. Oligomer components can be configured so that reactive groups are protected, exposed, and/or created relative to a parent compound, as appropriate. An oligomer component may correspond to a portion or all of a subunit of an oligomer, a dimer of subunits, a trimer of subunits, etc. Exemplary oligomer components include nucleic acid components, such as deoxyribonucleotides, ribonucleotides, peptide nucleic acids, or analogs, relatives, derivatives, or portions thereof. Exemplary chemistries for nucleic acid oligomer synthesis can include phosphoramidite, phosphodiester, phosphotriester, and/or H-phosphonate, among others. Table 1 below lists exemplary chemical processing steps and reagents for addition of a subunit during synthesis of a nucleic acid oligomer using phophoramidite chemistry.

TABLE 1
Exemplary Subunit Addition Cycle

| Step | | | # of |
|---|---|---|---|
| # | Step Description | Chemicals | Cycles |
| 1 | Deblocking | Trichloroacetic acid/ | 2 |
| | | Methylene Chloride | |
| 2 | Wash After Deblocking | Acetonitrile | 1 |
| 3 | Activation | 1-H-tetrazole/Acetonitrile | 1 |
| 4 | Base Addition (T, C, G | (T, C, G or A) | 1 |
| | or A) | Phosphoramidite/Acetonitrile | |
| 5 | Capping B | n-Methylimidazole/ | 1 |
| | | Tetrahydrofuran | |
| 6 | Capping A/Wash | Acetic Anhydride/Pyridine/ | 1 |
| | | Tetrahydrofuran | |
| 7 | Oxidation | Iodine/Pyridine/ | 1 |
| | | Tetrahydrofuran/Water | |
| 8 | Wash After Oxidation | Acetonitrile | 1 |

Further aspects of nucleic acid and peptide nucleic acid (PNA) synthesis are described in the following references, which are incorporated herein by reference: Khudyakov, Y. E. and Fields, H. A., “Artificial DNA—Methods and Applications,” CRC Press, 2003; Agrawal, S., “Protocols for Oligonucleotides and Analogs—Synthesis and Properties,” Humana Press, 1993; Eckstein, F., “Oligonucleotides and Analogues—A Practical Approach,” Oxford University Press, 1991; Agrawal, S., “Protocols for Oligonucleotide Conjugates—Synthesis and Analytical Techniques,” Humana Press, 1994; Gutte, B., “Peptides—Synthesis, Structures, and Application,” Academic Press, 1995; Nielsen, P. E. and Egholm, M., “Peptide Nucleic Acids—Protocols and Applications,” Horizon Scientific Press, 1999; and Nielsen, P. E., “Peptide Nucleic Acids—Methods and Protocols,” Humana Press, 2002.

Other exemplary oligomer components include amino acids, or analogs, relatives, derivatives, or portions thereof, to form peptides or peptide analogs (peptidomimetics). Further aspects of peptide synthesis are described in the following references, which are incorporated herein by reference: Grant, G. A., “Synthetic Peptides—A User's Guide,” W.H. Freeman and Company, 1992; Dunn, B. N. and Pennington, M. W., “Peptide Analysis Protocols,” Humana Press, 1994; and Bodanszky, M., “Principles of Peptide Synthesis,” Springer-Verlag, 1984. Additional exemplary oligomer components can include carbohydrates, lipids, metalorganic compounds, etc.

Ancillary reagents can include any other reagents that facilitate or augment oligomer synthesis. Such ancillary reagents can include reagents for capping (protection of reactive groups), deprotection, oxidation, reduction, cyclization, washing, labeling (such as with dyes), etc.

Oligomers generally include any molecule formed of two or more covalently linked subunits. The term oligomer, as used herein, also is intended to encompass polymers of any size or complexity. Accordingly, an oligomer can have any suitable number of subunits, for example, greater than ten, greater than one-hundred, or greater than one thousand subunits, among others. The various subunits of an oligomer can be structurally identical (such as oligomers with a repeated subunit), structurally related but including distinct subunits (such as oligomers of different nucleotides or amino acids), and/or structurally unrelated (such as oligomers including different structural classes of subunits), as desired. Oligomers synthesized by the systems described herein can have a defined size (or length), composition, and sequence of subunits. However, such oligomers can be synthesized as mixtures of oligomers, such as degenerate oligonucleotides synthesized with a mixture of nucleotide components at one or more positions of the oligonucleotides.

The oligomers can be used for any suitable purpose(s). For example, nucleic acid oligomers can be used as probes (e.g., fluorescence in situ hybridization (FISH) probes), primers (e.g., polymerase chain reaction (PCR) primers), substrates, test compounds for screens, and/or reagents, among others. Amino acid polymers similarly can be used as probes, primers, substrates (e.g., enzyme substrates such as kinase substrates), test compounds for screens, and/or reagents, among others.

D. Fluid Removal Mechanisms

Reagents, including reacted derivatives thereof, can be removed from reaction vessels using one or more fluid removal mechanisms of the synthesis station. A fluid removal mechanism can remove excess/unreacted reagent from a reaction vessel. The reagent removal can be performed at the synthesis site at which the reagent was dispensed to the reaction vessel. Alternatively, or in addition, the fluid removal mechanism can remove the reagent after the reaction vessel has been moved from the synthesis site. In some embodiments, synthesis throughput can be increased by including two or more separate/independent fluid removal mechanisms.

The fluid removal mechanism can be configured to push and/or pull fluid from a reaction vessel (or from a plurality of reaction vessels at the same time). For example, the fluid removal mechanism can exert a positive pressure to push the fluid through the reaction vessel. Alternatively, or in addition, the fluid removal mechanism can exert a negative pressure to pull the fluid from the reaction vessel. The use of a negative pressure can provide some advantages, such as (1) reducing the potential for a dispenser and a removal mechanism to collide, and (2) reducing the amount of aerosol created, particularly of toxic/flammable reagents. In some examples, a positive pressure can be exerted from above the reaction vessel and/or a negative pressure exerted from below the reaction vessel (or above/below a support matrix of the vessel). In some embodiments, the fluid removal mechanism can be configured to move reagents through reaction vessels, so that the reagents enter and exit the reaction vessels at different sites of the vessels, such as opposing sides of each vessel.

The fluid removal mechanism can be configured to operate on one reaction vessel at a time or on a set of two or more reaction vessels at the same time. Accordingly, the fluid removal mechanism can be disposed adjacent each of the synthesis sites concurrently or can move among the synthesis sites of a synthesis station, for example by sliding back and forth and/or movement along two axes, among Others, to selectively remove reagent(s) from subsets of the reaction vessels disposed in the synthesis station. The fluid removal mechanism thus can be configured to remove fluid from reaction vessels while the vessels are moving or stopped. In some embodiments, the fluid removal mechanism can be connected to the reagent dispenser, for example, connected to a dispense head thereof. In some embodiments, the fluid removal mechanism can move vertically to engage one or more reaction vessels from above or below the reaction vessels, to enable reagent removal. Alternatively, or in addition, the reaction vessels can be moved into engagement with the fluid removal mechanism.

The fluid removal mechanism can include a waste reservoir into which removed reagents are placed. The waste reservoir can be a common compartment that receives reagents removed from reaction vessels disposed in a plurality of the synthesis sites, or separate compartments to receive reagents removed from reaction vessels in individual synthesis sites, among others. In some embodiments, removed reagents (termed waste reagents) can be drained from the waste reservoir as the fluid removal mechanism is removing reagents from reaction vessels. For example, the waste reservoir can include an “on-line” reservoir into which the waste reagents are moved from the reaction vessels, and an “off-line” reservoir from which the waste reagents can be drained for removal from the synthesis system while the system is in operation synthesizing oligomers. The on-line and off-line reservoirs can be at the same or different pressures, or adjustable therebetween, among others.

II. Conveyors

The synthesis system can include one or more conveyors. A conveyor is any device configured to move reaction vessels to, from, and/or within the synthesis station. The conveyor can include one or more vessel receivers (holders) and one or more drivers that move the vessel receivers.

A vessel receiver (or receiver site) can be any structure that receives (and generally holds and supports) a reaction vessel (or vessels) within the synthesis system. The receiver can define a discrete position for the reaction vessel on the conveyor. For example, the receiver can define an opening into which the reaction vessels fit, and/or the receiver can include protrusions (posts, walls, etc.) that flank a received reaction vessel, and/or the like. The conveyor can include a plurality of receivers, each configured to receive one or more reaction vessels. In some embodiments, the receivers are arranged to define a sequence in which reaction vessels can be moved through the synthesis station. In such an arrangement, the receivers can be configured to be moved one-by-one, in pairs, triplets, etc., into and out of the synthesis station. The receivers can have a constant or variable spacing. For example, a constant spacing can be provided if a plurality of receivers are connected to one another. The receivers can be connected by a fixed or flexible connection. With a fixed connection, the receivers can be disposed in a linear or planar array, among others. The planar array can be a rectilinear array, a radial array, etc. Receivers can be connected to define discrete sets of receivers. Accordingly, the conveyor can be configured to move the discrete sets of receivers independently and/or concertedly. Alternatively, connected receivers can define a single connected set. The single connected set can define a connected loop of any suitable shape (such as circular, oval, etc.), a linear array of receivers, and/or the like.

The conveyor device can hold the reaction vessels in a single lane (single file), as shown in FIG. 1, or the conveyor device can be configured to hold the reaction vessels in multiples lanes or tracks disposed adjacent one another. The conveyor device can define any suitable number of adjacent lanes/tracks, such as two, four, eight, or more lanes adjacent one another. Vessel holders in adjacent lanes can be in register, that is, aligned transversely, or out of register. Furthermore, movement of the vessel holders in adjacent lanes of the conveyor can be coupled or independent.

A driver can be any mechanism that changes the position of the receivers. The driver can be configured to move the receivers at an adjustable, a constant, and/or variable speed. The driver can include a drive mechanism, such as a motor, and an optional coupling structure (such a gear(s), belt(s), an arm(s), etc.) that connects operation of the motor to movement of the receivers. The motor and/or coupling structure can be configured to move the receivers in one direction, in opposing directions, laterally, and/or vertically, among others. In some embodiments, the driver can be configured to move the receivers to predefined positions, for example, stopping movement of the receivers at positions reached by movement of the receivers through integer multiples of the spacing of adjacent receivers.

III. Reaction Vessels

The synthesis system can synthesize oligomers in reaction vessels. The reaction vessels generally include any container and/or other support that can receive reagents and hold oligomer intermediates in association with the container during oligomer synthesis. Exemplary reaction vessels include test tubes, microplates, PCR plates, flow-through columns, planar structures (such as biochips), etc.

Reaction vessels can have one or more openings. Reaction vessels with one opening receive and remove reagents in opposing directions, respectively, through the same opening. Reaction vessels with two or more openings, such as columns, can receive and remove the reagents through one of the openings or through different openings, so that the reagents flow through the reaction vessels. Reaction vessels with two or more openings can include porous members, such as filters, that partially resist fluid flow, so that reagents can be temporarily retained in the reaction vessels.

Reaction vessels can include (or simply comprise) a support surface to which oligomer intermediates are connected during oligomer synthesis. The support surface can provide a covalent linkage to oligomer intermediates (and oligomers). Accordingly, the support surface can include a moiety that reacts with an oligomer component. Alternatively, or in addition, the support surface can provide a noncovalent association to oligomer intermediates, such as binding through a specific binding pair (antibody-antigen, receptor-ligand, enzyme-substrate, complementary nucleotide strands, etc.). The support surface can be part of a support matrix. The support matrix can be included in the reaction vessel, such as part of a wall of the vessel, or can be included in beads and/or other particles that are held by the reaction vessels.

Reaction vessels can be distinguishable so that different oligomers synthesized in the vessels are identifiable. The reaction vessels can be distinguished by their positions in the conveyor. Alternatively, or in addition, the reaction vessels can be distinguished by indicia associated with the reaction vessels, that is, included in, on, or about the reaction vessels. Such indicia can include any symbol(s), alphanumeric character(s), code (such as a barcode, color(s), etc.), and/or the like. In some embodiments, barcodes and/or other indicia can be printed onto the reaction vessels or printed onto labels that are affixed to the reaction vessels. The barcodes and/or other indicia can be placed on the reaction vessels before and/or after introduction of the reaction vessels into an automated synthesis system. For example, the reaction vessels can be prelabeled with indicia during their manufacture, or the automated synthesis system can include an indicia placement mechanism that adds indicia to the reaction vessels, among others.

IV. Controllers

The synthesis system can be automated with a controller. The terms “automated” and “automatically,” as used herein, mean configured for sustained operation without human intervention. For example, an automated system can be configured to synthesize a plurality of oligomers without human intervention. The controller can be any device that processes data, such as a computer or other computing/communicating device. The controller can be coupled to some or all of the devices/mechanisms of the synthesis system to control and coordinate their operation. The controller can include a memory that stores system instructions, such as software, for controlling and coordinating the other devices/mechanisms.

A user of the synthesis system also can input sequences, user instructions and/or user preferences to the controller through a user interface. The user instructions and/or user preferences can include oligomers to synthesize (such as the structure (sequence) of each oligomer), synthesis scale for each oligomer, type of reaction vessel to use (such as selection of a column with a particular first oligomer subunit pre-coupled to the column), an order in which oligomers are to be synthesized (such as a priority for each oligomer), post-synthesis processing instructions and/or reaction vessel placement, a selected reaction progression (such as a batch or an asynchronous approach), etc. The user interface can include a keyboard, a keypad, a mouse, a trackball, a touchscreen, and/or a voice and/or vision recognition system, among others. Alternatively, or in addition, sequences, instructions, preferences can be introduced, via electrical and/or optical wire, among others, and/or wirelessly, through a communications interface, such as a network port, a USB port, and/or a memory-device reader, among others.

Based on inputs, the controller can determine how each reaction vessel should be processed. For example, the controller can determine the reagent dispensing requirements (reagent profile) for each vessel, including order of reagent addition, amount of each reagent to be added, reagent residence time in the vessel, etc. In addition, the controller can create a queue of oligomers to be synthesized, which can be modified by user intervention, for example, to allow the queue to be adjusted to allow higher priority oligomers to be inserted near or at the front of the queue. In addition, the controller can, in some cases, keep track of the position of each vessel in the system as the conveyor moves the vessel. Furthermore, the controller can be configured to communicate with other corporate/computing systems to facilitate efficient oligomer synthesis. For example, this communication can enable (1) tracking of oligomer synthesis and order fulfillment, (2) monitoring of oligomer quality (such as through communication with a Quality Control (QC) system) and feedback to the synthesis system to re-synthesize oligomers that don't meet quality standards and/or to adjust operation of synthesis components to improve quality, (3) timely ordering of additional reagents (such as through communication of reagent usage or requirements to a Materials Resource Planning (MRP) system), etc. Accordingly, the amount of human intervention necessary for extended operation of the synthesis system can be reduced or minimized relative to conventional processing.

V. Sensors

The synthesis system can include one or more sensors. Each sensor can be configured to sense any suitable aspect of the system, such as conveyor/receiver operation or position; reaction vessel identity, position, and/or presence/absence; dispenser status or operation (such as reagent levels in reagent reservoirs, amount of a reagent dispensed to a reaction vessel, accuracy of dispensing, etc.); reaction efficiency for one or more steps of an oligomer synthesis; and/or a condition in the synthesis station (such as temperature, pressure, gas content, etc.); among others. The sensor can be in communication with a controller for sensor actuation and processing sensor data.

Sensors can be optical sensors, electrical sensors, and/or mechanical sensors, among others. Exemplary optical sensors can be configured to sense, for example, conveyor positions, and/or to read indicia adjacent receivers and/or reaction vessels. Accordingly, the optical sensor can include a barcode scanner. In some examples, optical sensors can be configured to (1) receive user inputs, (2) sense the presence/absence/identity of reaction vessels in receivers, (3) sense the fluid level in reagent reservoirs, and/or the like. In some examples, optical sensors can be configured to measure a reaction efficiency, such as an absorbance or fluorescence of the contents of a reaction vessel or a fluid removed from the vessel (e.g., to determine the amount of a protecting group removed and thus the amount of a subunit added to a growing oligomer in a coupling step). Information about reaction efficiency can be communicated to the controller to enable the controller to take a suitable action, if warranted. Exemplary actions can include (1) automatically starting a second synthesis of an oligomer deemed to have an unacceptable reaction efficiency during the first synthesis (the second synthesis can be initiated before or after the reaction vessel for the first synthesis exits the synthesis station), (2) cleaning and/or adjusting dispensers, (3) creating a warning signal, and/or (4) terminating synthesis of oligomers.

Exemplary sensors can sense the volume dispensed. For example, the sensors can include one or more mass flow transmitters in the reagent dispenser to measure fluid flow through conduits to dispense structures. Mass flow transmitters can be configured to determine the mass (and volume) of fluid dispensed to each reaction vessel, for example, by the rate of heat transfer produced by fluid movement. Alternatively, or in addition, the sensors can be rotation sensors configured to sense (and control) the number of degrees (and/or times) a pump piston rotates. In some examples, volumes of reagent dispensed can be determined based on the time valves are kept open and an expected flow rate during this time. However, mass flow transmitters and/or pump rotation sensors can be more accurate because they are less prone to errors due to changes in flow rate (for example, with changes in pressure in reagent reservoirs). Accordingly, a problem in dispensing a reagent can be detected more quickly. This can prevent an overflow or flooding situation in which an undesired excess of reagent is added to a reaction vessel. In addition, early detection of a problem during synthesis of a particular oligomer can enable the synthesis system to initiate re-synthesis of the particular oligomer automatically. With an asynchronous approach, the re-synthesis (remake) can be initiated more quickly than in a batch approach, for example, with the next unreacted reaction vessel that enters the synthesis station and thus before the reaction vessel with the problem synthesis would have been completed (if the problem had not occurred).

The sensors can be electrical, mechanical, and/or optical sensors. Exemplary electrical sensors can include a position sensor for the conveyor, and/or a conductivity sensor for a reagent reservoir to determine a reagent level. Mechanical/electrical sensors can include a pressure-differential sensor to measure the level of a reagent in a reagent reservoir, such as periodically, on demand, or continuously, among others.

VI. Robotic Transfer Devices

The synthesis system can include one or more robotic transfer devices. A robotic transfer device, as used herein, can be any device that moves reaction vessels automatically relative to the conveyor. The robotic transfer device can be configured to engage reaction vessels selectively, and then move the engaged reaction vessels to and/or from the conveyor, and/or between different positions of the conveyor. In some embodiments, the robotic transfer device(s) can engage individual reaction vessels or sets of vessels and add them to the conveyor, upstream of the synthesis station, before synthesis, or remove them from the conveyor after synthesis. In some examples, the robotic transfer device(s) can remove reaction vessels from a position within the synthesis station. For example, the robotic transfer device can be configured to remove a reaction vessel holding a full-length oligomer, from within an array of synthesis sub-stations, so that the full-length oligomer can be processed further without the necessity of passing through the remainder of downstream synthesis sub-stations.

The robotic transfer device can engage and move the reaction vessels by any suitable mechanisms. In some embodiments, the robotic transfer device can include jaws that can grip the reaction vessels. Alternatively, or in addition, the robotic transfer device can engage the reaction vessels using openings and/or protrusions on the reaction vessels. The robotic transfer device can be configured to move the reaction vessels along any suitable number of axes. In some embodiments, the robotic transfer device can move the reaction vessels in relation to three orthogonal axes.

VII. Post-Synthesis Processing Devices

The synthesis system can include one or more post-synthesis processing devices or stations. The post-synthesis processing devices/stations can include any device or station that modifies the structure or concentration of an oligomer that has exited the synthesis station, or the disposition of such an oligomer relative to its corresponding reaction vessel. Accordingly, the post-synthesis processing device can be configured to uncouple an oligomer from a reaction vessel, for example, by cleavage of the oligomer from a support surface of the reaction vessel. In some embodiments, the post-synthesis-processing device can include a vacuum plate. Alternatively, or in addition, the post-synthesis processing device can be configured to (1) remove or structurally alter groups (such as protective groups) on the oligomer, (2) conjugate a moiety (or moieties) to the oligomer (such as a dye) (3) dilute or concentrate an oligomer, (4) measure a yield, purity, or composition of an oligomer, (5) remove particles (e.g., a support matrix) from a reaction vessel, and/or (6) separate an oligomer from its reaction vessel, among others. Alternatively, or in addition, rather than additional processing after synthesis, a reaction vessel can be discarded, such as by placement in a discard bin, for example, if a problem was detected during synthesis of an oligomer in the vessel so that the oligomer was deemed defective.

A post-synthesis processing device can be accessed and controlled by any suitable mechanisms. For example, the reaction vessels can be placed into the post-synthesis processing device manually, and/or automatically with a robotic transfer device, as described above. Alternatively, or in addition, the post-synthesis processing device can be accessible from the conveyor, so that the conveyor moves the reaction vessels to the post-synthesis processing device from the synthesis station. The post-synthesis processing device can be configured to be operated automatically by the controller of the system for coordination with other devices/mechanisms of the system. Accordingly, the post-synthesis processing device can provide a batch approach and/or an asynchronous (“continuous”) approach to post-synthesis processing.

VIII. Reaction Progressions

The synthesis system can be configured to synthesize a set of oligomers with any suitable reaction progression or progressions. A reaction progression, as used herein, is a temporal sequence in which oligomer syntheses are conducted. The temporal sequence can relate to (1) the order in which different oligomer syntheses are initiated, (2) the times at which these oligomer syntheses are initiated, and (3) the times at which these oligomer syntheses are completed. Each of these aspects of the temporal sequence can be selected as a preference and/or to optimize throughput, among others.

The order in which oligomer syntheses are initiated can be fixed or flexible. A fixed order may include, for example, an order in which synthesis instructions corresponding to sequences of the oligomers are received by the controller. Alternatively, the order may be flexible, so that the order can be varied based, for example, on a priority assigned to each oligomer. In some embodiments, the controller can be configured to define an order of synthesis that optimizes throughput. As an example, oligomers of a similar length can be grouped or a set of oligomers of increasing length can be synthesized sequentially, so that synthesis of a longer oligomer (with a longer time of synthesis) does not delay exit of a shorter oligomer (with a shorter time of synthesis) from the synthesis station.

The times at which oligomer syntheses are initiated can be similar or different for a set of oligomers.

Oligomer synthesis can be initiated at similar or substantially the same times, for example, to provide a batch synthesis of the set of oligomers. For example, if a synthesis station has “N” synthesis sites (and/or sub-stations) for reaction vessels, up to “N” oligomers (or oligomer mixtures) can be started concomitantly or at substantially the same time (based on whether the dispenser dispenses reagents simultaneously or sequentially to the reaction vessels). In batch or synchronous synthesis, each corresponding subunit of the oligomers can be coupled during the same reaction cycle. As an example of batch synthesis, a first oligomer subunit is coupled to each reaction vessel during a first reaction cycle, and then a second subunit is coupled to the first oligomer subunit of each vessel during a second reaction cycle, and so on.

Alternatively, oligomer syntheses can be initiated at substantially different times in a synthesis station to provide asynchronous or staggered oligomer synthesis. In asynchronous synthesis, at least two noncorresponding subunits of a set of oligomers can be coupled to oligomer intermediates during a reaction cycle with a corresponding set of reaction vessels. As an illustration, during one reaction cycle, a tenth subunit can be added to a first oligomer intermediate, a fifth subunit to a second oligomer intermediate, and a first subunit to a third oligomer intermediate.

In some embodiments, a synthesis station can be configured to switch between batch and asynchronous synthesis as appropriate or desired. For example, a synthesis station can perform batch synthesis initially and then switch to asynchronous synthesis if such synthesis becomes a more efficient approach.

The times at which oligomers are completed can be determined by their relative initiation times and their relative rates of reagent addition. Oligomer syntheses that are initiated together can be completed at substantially the same time, or at different times, for example, if the oligomers synthesized are of different lengths and/or if one of the oligomer syntheses is excluded from one or more reaction cycles. In some embodiments, oligomers exit the synthesis station according to the order in which they entered the station.

The synthesis systems of the present teachings can be configured to concurrently synthesize oligomers of different lengths. In some examples, the length of an oligomer to be synthesized can determine the number of synthesis sub-stations at which a subunit is added to a growing oligomer. Alternatively, or in addition, the length of an oligomer to be synthesized can determine the number of subunits added at an individual synthesis site (and/or sub-station).

### IX. EXAMPLES

The following examples describe selected aspects and embodiments of the present teachings, including systems for automated oligomer synthesis, and methods of using such systems. These examples and the various features and aspects thereof are included for illustration and are not intended to define or limit the entire scope of the present teachings.

### Example 1

### Conveyors

This example describes exemplary conveyors that can be included in the automated synthesis systems of the present teachings; see FIGS. 2 and 3.

FIG. 2 shows a conveyor 60 configured to move reaction vessels to and from synthesis station 24. Conveyor 60 can be structured as a closed loop of any suitable shape (such as circular, serpentine, folded, partially linear, and/or the like). As a result, unreacted reaction vessels 62 (unhatched) can be added to the conveyor (in single file or in pairs, triplets, etc. by adjacent lanes of the conveyor), and reacted reaction vessels 64 (hatched) with completed oligomers 22 can be removed from the conveyor, at a single region of the conveyor, shown at 66. Alternatively, or in addition, reaction vessels can be added to the conveyor and removed from the conveyor at different positions. Furthermore, in some example, the synthesis system can be configured to remove reaction vessels from the conveyor at two or more different positions. For example, reaction, vessels with full-length oligomers can be removed from within the synthesis station (such as between synthesis sub-stations) before complete transit through the synthesis station, and/or downstream of the synthesis station after complete passage through the synthesis station. In some examples, reaction vessels can make two or passes through the synthesis station, such as by bi-directional movement of the conveyor and/or by remaining on the conveyor for more than a single lap of a corresponding vessel holder.

In some examples, a robotic transfer device can be used, based on signals from the controller, to select and place suitable types of reaction vessels (such as A, G, C, and T columns for nucleotide oligomer synthesis) on the conveyor based on the identity of the initial subunit (or set of subunits) of each oligomer to be synthesized.

FIG. 3 shows a conveyor 70 configured as a carousel 72 to move reaction vessels around a circular path to and from synthesis station 24. Unreacted reaction vessels 62 can follow an arcuate path into the synthesis station and exit as reacted reaction vessels 64 on opposing sides of the station. Carousel 72 can provide fixed relative positions for the reaction vessels and can rotate in one direction or in opposing directions. Furthermore, the carousel can define synthesis sites arrayed along a circumferential path, as shown here, and/or arrayed radially on the conveyor.

### Example 2

### Synthesis Station and Refillable Reagent Reservoir

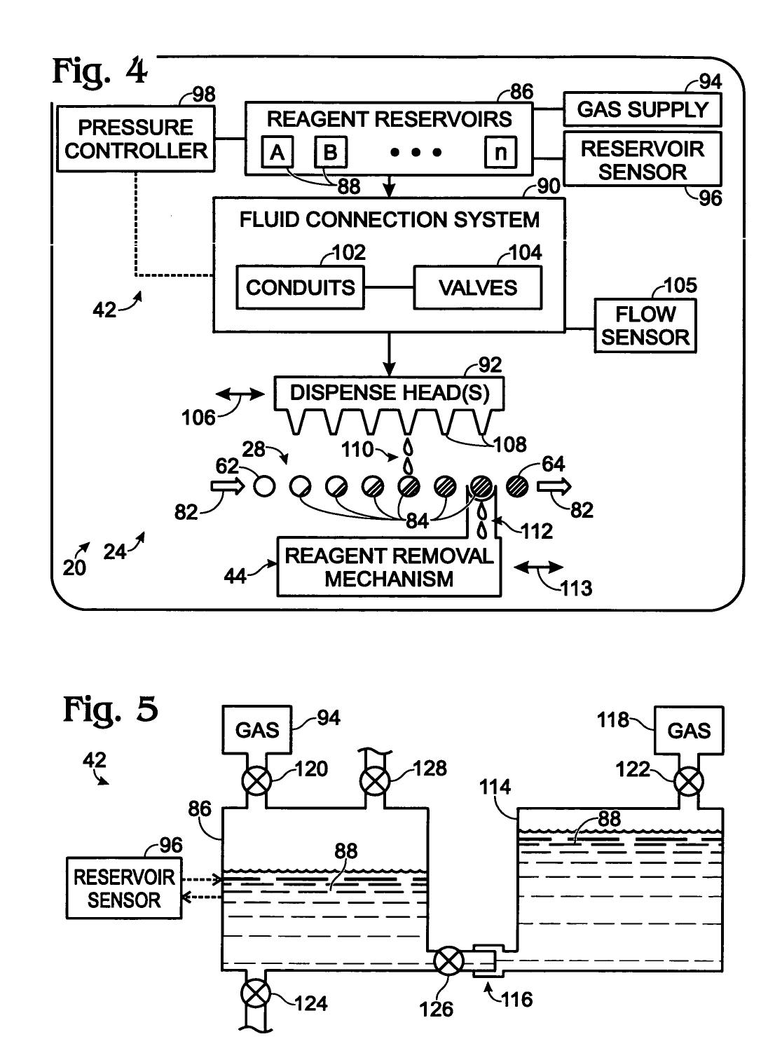

This example describes an exemplary synthesis station and a refillable reagent reservoir that can be included in the automated synthesis systems of the present teachings; see FIGS. 4 and 5. Other aspects of an exemplary synthesis system 20 in which the synthesis station can be included are described above in relation to FIG. 1.

FIG. 4 shows selected aspects of synthesis station 24 of synthesis system 20. Synthesis station 24 can include a reagent dispenser 42 and a fluid removal mechanism 44 configured, respectively, to move reagents to and from reaction vessels 28. In particular, unreacted and reacted reaction vessels 62, 64, respectively, can enter and leave the synthesis station by unidirectional movement through the station, indicated at 82. Each intermediate reaction vessel 84 can receive reagents in one or more positions within the synthesis station.

Reagent dispenser 42 can include reagent reservoirs 86 that store and release reagents 88 for oligomer synthesis through fluid connection system 90 to one or more dispense head(s) 92. The dispenser can include any suitable number of reagents, indicated here as A, B, . . . , n. Some or all of the reservoirs can be connected to a gas supply 94 and/or a reservoir sensor 96. Gas supply 94 can maintain a desired atmosphere inside the reservoirs, such as an inert and/or a dry atmosphere (for example, with argon gas). Reservoir sensor 96 can sense the fluid levels of the reservoirs, so that the reservoirs can be replenished automatically at appropriate times from back-up supply reservoirs and/or so that a user of the system can be informed of the fluid levels, among others. The reservoir sensor can measure pressure differential, the position of the top surface of the reagent, a summed volume of fluid released from the reservoir, etc. The reagent reservoir also can be connected to a pressure controller 98. The pressure controller can exert a pressure on the reagents so that they are urged from the reservoirs. The pressure controller can be the gas supply 94 or a separate pump, among others. Alternatively, or in addition, the pressure controller can exert a pressure on the fluid connection system 90 and/or the dispense head 92.

Fluid connection system 90 can provide fluid communication between reagent reservoirs 86 and dispense head 92. Accordingly, fluid connection system 90 can include conduits 102 and optional valves 104 that direct and regulate fluid movement, respectively. The conduits can extend through a manifold that provides branched fluid communication. A flow sensor 105 can be disposed to sense movement of reagents through one or more of the conduits. The flow sensor can be, for example, a mass flow transmitter.

Dispense head 92 can define the positions at which reagents are dispensed. For example, the dispense head can be configured to reciprocate, shown at 106, between the synthesis sites at which the reaction vessels are disposed. In some embodiments, the dispense head can be configured to move up and down. The dispense head can include one or more dispense structures 108 (such as tips and/or openings) from which reagents can be dispensed. Dispense structures 108 can be connected to individual reagent reservoirs so that the structures are in one-to-one correspondence with the reagent reservoirs or two or more reagent reservoirs can be connected to one dispense structure, among others. The dispense structures can dispense reagents at different times or at the same time. For example, one of the dispense structures can dispense a reagent while the other dispense structures are inactive, shown at 110. However, the dispense structures can be spaced in accordance with the synthesis sites (and the reaction vessels disposed therein) so that two or more of the dispense structures can be aligned concurrently with different synthesis sites. In this case, two or more of the dispense structures can dispense reagents concurrently. In the present illustration, the six dispense structures can be aligned concurrently with six reaction vessels.

Fluid removal mechanism 44 can be configured to pull fluid from the reaction vessels, shown at 112. Mechanism 44 can reciprocate, shown at 113, to remove fluid selectively from individual reaction vessels.

FIG. 5 shows one of the reagent reservoirs 86 of dispenser 42 connected to a refill reservoir 114 using interface 116. Reagent and refill reservoirs 86, 114, respectively, can hold the same reagent 88 and can be placed under pressure using gas supplies 94, 118, respectively. Gas valves 120, 122 can control fluid communication between the gas supplies and the reservoirs. Dispense valve 124 can control flow of the reagent toward the dispense head. Refill valve 126 can control fluid communication at interface 116 between the reservoirs. The refill valve can be opened automatically based on a reagent level sensed by reservoir sensor 96, or opened manually, among others. In either case, a pressure differential between the reservoirs can push a volume of the reagent from the refill reservoir to the reagent reservoir. A vent valve 128 can be operated to release any excess pressure from reagent reservoir 86.

### Example 3

### Waste Removal Mechanisms

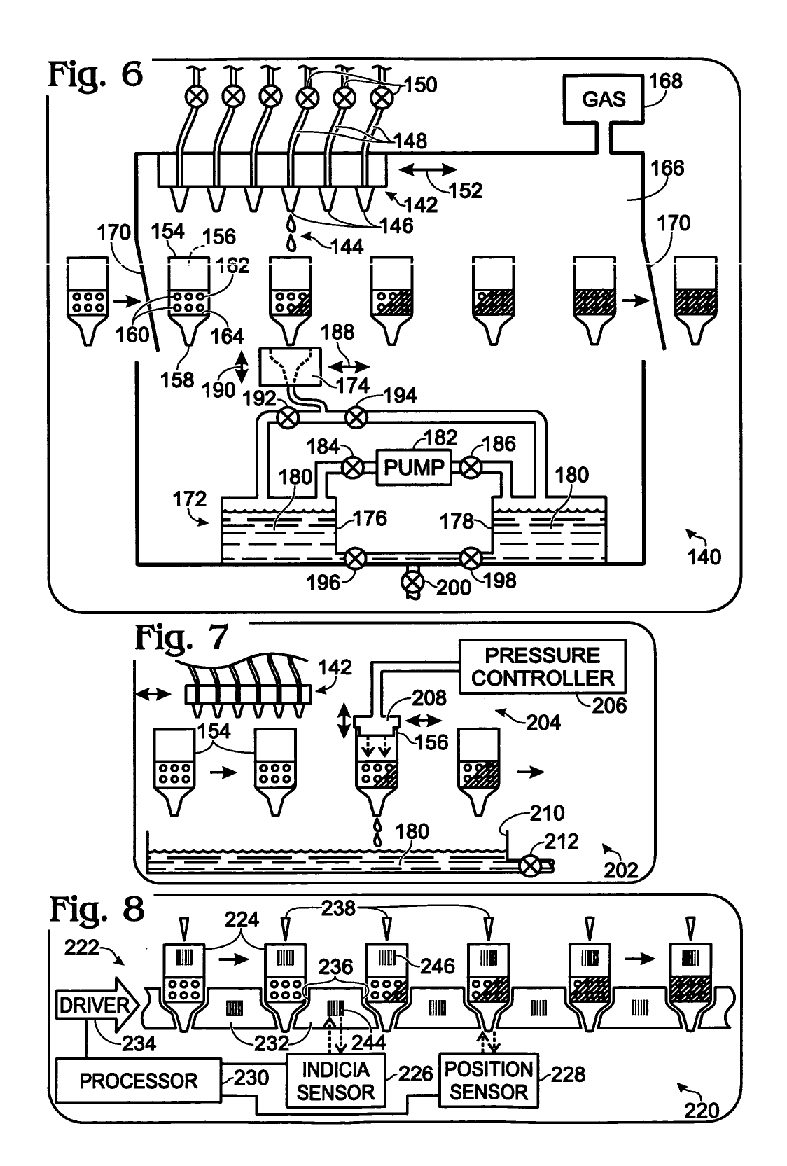

This example describes exemplary waste (fluid) removal mechanisms to remove waste reagents. This example also describes other selected aspects of systems of the present teachings, particularly reaction vessels and isolation of synthesis stations from the ambient environment; see FIGS. 6 and 7.

FIG. 6 shows selected portions of an exemplary synthesis station 140 of a system for automated oligomer synthesis. Station 140 can include a dispense head 142 that dispenses reagents, shown at 144, from dispense tips 146. Each tip 146 can be in fluid communication with a separate conduit 148, and passage of the reagents to their respective tips can be controlled by optional valves 150 (and/or by controlled operation of a pump). Head 142 can reciprocate, as shown at 152, and/or move horizontally in two dimensions.

Reaction vessels can be columns 154 positioned at predefined sites in the synthesis station to receive the dispensed reagents. Each column 154 can include opposing openings 156, 158 in fluid communication for passage of fluid through the columns. Upper opening 156 can serve as an inlet through which the reagents are received, and lower opening 158 can serve as an outlet from which the reagents are removed. The columns can include a support matrix, such as particles 160, that have a support surface 162 at which oligomer synthesis can occur. Particles 160 can be retained in the columns by a filter 164 than can retain particles 162. The filter also may retain fluid temporarily in the column.

Synthesis station 140 can define a chamber(s) 166 that is separated from the ambient environment. Chamber 166 can have an internal environment with a gas composition defined by a gas supply 168. Accordingly, the internal environment can be controlled, for example, by providing an environment, such as an inert and dry environment that is different than the ambient environment outside the chamber. Alternatively, or in addition, reaction vessels can be treated individually with gas to provide them with a desired environment, such as an inert and/or dry reaction environment. Transition structures 170 (such as single doors, double doors, openings, transition chambers, etc.) can be positioned at the entrance and exit to chamber 166 to provide a transition zone or barrier between the ambient environment and the controlled environment of the synthesis station. Each transition structure can open (or be open) to allow a column to pass through. The transition structure then can remain open or can close after passage of the column, for example, to restrict change of the internal environment. Doors can be hinged or sliding, among others, and can be controlled electrically or mechanically.

Synthesis station 140 can include a fluid removal mechanism 172 that removes fluid (and reagents) from the columns. Fluid removal mechanism can include a cap 174 that engages the columns and/or column holders, and waste reservoirs 176, 178 that receive waste reagents 180 from the cap. The fluid removal mechanism also can include a pump 182 to create a negative pressure selectively in either or both of the waste reservoirs by operation of pump valves 184, 186, which pulls waste reagents 180 from the columns. Cap 174 can be configured to move horizontally and vertically, shown at 188 and 190, respectively, to engage one or more columns adjacent their respective outlet openings 158, while the columns are moving or stopped. This engagement directs fluid flow through the cap by forming a temporary seal against the exterior surface of the column(s) and/or column holder(s), which creates a pressure drop between the opposing openings of the column. Accordingly, waste reagents 180 are pulled from each column to accumulate in either first waste reservoir 176 or second waste reservoir 178, based on selective operation of valve 192 or 194, respectively, to provide selective fluid communication. Each waste reservoir can be emptied, while the other reservoir is receiving waste fluid, through selective operation of drain valves 196, 198, and 200. Accordingly, fluid removal mechanism 172 can continue to operate as its accumulated waste fluids are emptied, allowing oligomer synthesis to proceed nonetheless.

FIG. 7 shows selected portions of another exemplary synthesis station 202 of a system for automated oligomer synthesis. Synthesis station 202 can include a waste removal mechanism 204 based on positive pressure. In particular, removal mechanism 204 can include a pressure controller 206 configured to exert a positive pressure adjacent inlet opening 156 through a cap 208. Cap 208 can be configured to move vertically and horizontally. The cap can fit into inlet opening 156 of each column and/or around the exterior perimeter of the column, among others. Waste reagents 180 can be received in a waste reservoir 210. The waste reservoir can be at ambient pressure so that this reservoir can be drained through a drain valve 212 while the waste removal mechanism is in operation.

### Example 4

### Conveyor and Sensors

This example describes an exemplary conveyor and exemplary sensors that can be included in the systems of the present teachings; see FIG. 8.

FIG. 8 shows selected aspects of a system 220 for automated oligomer synthesis. System 220 can include a conveyor 222 to move columns 224, conveyor-associated sensors 226, 228, and a processor (a controller) 230.

Conveyor 222 can include a plurality of column holders 232 and a driver 234 to move the column holders. Column holders 232 can define a plurality of openings 236 in which columns 224 can be received. Openings 236 can have a predefined or adjustable spacing. Driver 234 can move the openings to predefined positions, indicated at 238. The driver can be configured to move the openings to the predefined positions based on dynamic position data sensed by position sensor 228 and used by controller 230 to control driver 234. The predefined positions can determine an array of sites to which the driver can advance the columns. More generally, the controller can be configured to identify holders (and their columns), when moving or stopped, based on data or signals defining the positions of the holders within the synthesis system.

The controller also or alternatively can be configured to identify individual reaction vessels and/or their receivers (holders) based on indicia thereon. The identity of each holder opening 236 can be defined by indicia such as a barcode 244 disposed adjacent each opening. Indicia sensor 226 can be configured to sense each barcode. Sensed barcode data can be decoded by controller 230 to distinguish the different openings of the column holders. Alternatively, or in addition, each column 224 can include a different column barcode 246 that can be sensed and decoded by the indicia sensor and the controller, respectively.

### Example 5

### Synthesis Strategies

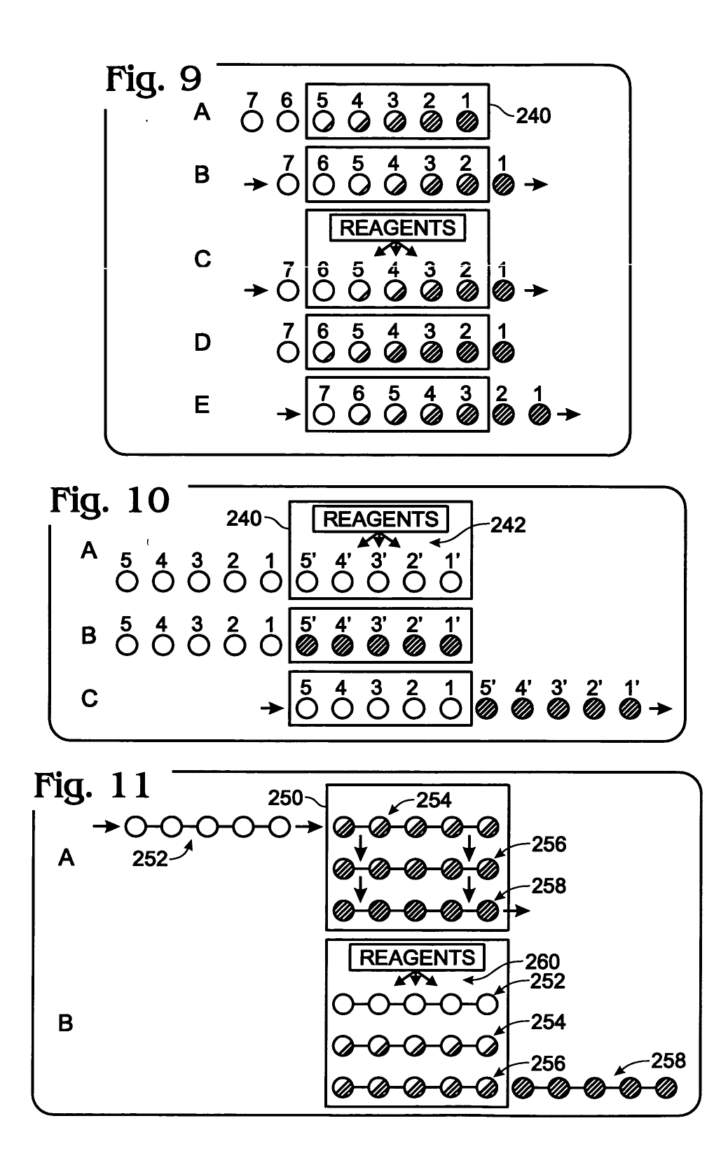

This example describes exemplary strategies for synthesis of oligomers in reaction vessels moved through a synthesis station; see FIGS. 9-11. In each of these figures, reaction vessels enter and exit the synthesis station individually along a single path. However, in some examples, a plurality of reaction vessels can enter the synthesis station along parallel paths so that any suitable number of reaction vessels can enter and exit the synthesis station at the same time.

FIGS. 9A-9E illustrate asynchronous (staggered) synthesis of oligomers in synthesis station 240.

FIG. 9A shows a set of seven reaction vessels, labeled 1-7. Vessels 1-5 are disposed in synthesis station 240 and are at various stages of oligomer synthesis. Vessel 1 holds a completed oligomer, and vessels 2-5, in order, hold oligomer intermediates at increasing stages of completion. Vessels 6 and 7 are unreacted and disposed upstream of the synthesis station.

FIG. 9B shows the disposition of vessels 1-7 after advancement by one position. Vessel 1, with its completed oligomer, has exited the synthesis station, and vessel 6 has entered the synthesis station. Vessels 2-5 have shifted by one position in the synthesis station.

FIGS. 9C-9E illustrate succeeding operations. FIG. 9C shows addition of reagents to each of the reaction vessels in the synthesis station. FIG. 9D shows the amount of synthesis resulting from reaction of the added reagents. Now, vessels 3-6 hold oligomer intermediates that are closer to completion than before reagent addition, and vessel 2 holds a completed oligomer. FIG. 9E shows the position of vessels 1-7 after advancement by another position. Vessel 2 has exited the synthesis station, unreacted vessel 7 has entered the station, and vessels 3-6 have advanced by one position within the station. Accordingly, some or all of the oligomers are partially synthesized in two or more positions within the synthesis station. In addition, introduction of unreacted vessels into the synthesis station can be coupled to removal of vessels with completed oligomers from the station, and vessels can follow a first in, first out principle of movement.

FIGS. 10A-10C illustrate batch synthesis of oligomers in synthesis station 240. FIG. 10A shows reaction vessels 1′-5′ disposed in the synthesis station, with each vessel in an unreacted configuration. Reagents are added, shown at 242, to achieve substantially synchronous growth of oligomer intermediates (within the capability of the reagent dispenser). FIG. 10B shows reaction vessels 1′-5′ after completion of oligomer synthesis but before removal from the synthesis station. FIG. 10C shows the position of vessels 1′-5′ with their completed oligomers after advancement of a new set of unreacted vessels 1-5 into the synthesis station. Accordingly, each set or batch of vessels is processed together to achieve synchronous (batch) oligomer synthesis.

FIGS. 11A-11B illustrate a combined batch and staggered approach to oligomer synthesis in synthesis station 250. FIG. 11A shows sets 252-258 of reaction vessels disposed in synthesis station 250 or upstream of the station. Each set of vessels includes a plurality of vessels that are connected to each other. Set 252 is unreacted and disposed upstream of the synthesis station. Sets 254-258 are at different stages of completion. However, the vessels within each set can hold oligomer intermediates at similar stages of completion if the final oligomers have a similar length. Arrows indicate directions in which the sets move. FIG. 11B shows the positions of the sets of vessels after movement of completed set 258 out of the station and movement of unreacted set 252 into the station. Reagents are added after movement, shown at 260. In other examples, the sets can move in one direction rather than orthogonal directions. Alternatively, or in addition, vessels of each set can be unconnected.

### Example 6

### Selected Aspects and Embodiments

This example describes selected aspects and embodiments of the present teachings, presented as a series of indexed paragraphs.

1. A system for automated oligomer synthesis, comprising: (A) a synthesis station including a dispenser configured to dispense reagents for oligomer synthesis to reaction vessels disposed in a plurality of synthesis sites of the synthesis station; (B) a conveyor device configured to move the reaction vessels to the plurality of synthesis sites of the synthesis station; and (C) a controller configured to receive data defining one or more oligomers for each reaction vessel and to control operation of the dispenser and the conveyor device so that the dispenser dispenses the reagents to each reaction vessel according to the one or more oligomers defined for the reaction vessel and also according to one or more of the synthesis sites in which the reaction vessel is placed by the conveyor device during synthesis of the one or more oligomers.

2. The system of paragraph 1, wherein the controller is configured so that at least one of the reaction vessels receives one or more of the reagents from the dispenser when the at least one reaction vessel is disposed in each of two or more of the synthesis sites so that the one or oligomer defined for the at least one reaction vessel is synthesized partially at each of the two or more synthesis sites.

3. The system of paragraph 1, wherein the controller is configured to signal the conveyor device to move a first subset of the reaction vessels holding completed oligomers out of the synthesis station while leaving a second subset of the reaction vessels holding incomplete oligomers in the synthesis station.

4. The system of paragraph 1, wherein the conveyor device is configured to move each reaction vessel through the synthesis station by sequentially placing the reaction vessel in each of the synthesis sites.

5. The system of paragraph 1, wherein the conveyor device is configured to place the reaction vessels at an integral number of predefined positions, and wherein the synthesis sites are included in the integral number of predefined positions.

6. The system of paragraph 1, the reaction vessels including indicia that identify the reaction vessels, the system further comprising a sensor in communication with the controller and configured to sense the indicia so that the controller can identify each reaction vessel.

7. The system of paragraph 1, wherein the synthesis station further includes reservoirs holding storage volumes of the reagents in fluid communication with the dispenser, and wherein the reservoirs are configured to be replenished with additions to the storage volumes during operation of the dispenser.

8. The system of paragraph 1, wherein the conveyor device is configured to move the reaction vessels in a closed loop.

9. The system of paragraph 1, wherein the synthesis station further includes a fluid removal mechanism configured to remove, from the reaction vessels, at least a portion of the reagents dispensed to the reaction vessels.

10. The system of paragraph 9, the reaction vessels being configured to permit fluid to travel through the reaction vessels between an inlet and an outlet disposed in fluid communication, wherein the dispenser is configured to dispense the reagents to the inlet, and wherein the fluid removal mechanism is configured to engage each reaction vessel and create a pressure drop between the inlet and the outlet.

11. The system of paragraph 9, wherein the fluid removal mechanism is configured to remove fluid selectively from fewer than all of the reaction vessels disposed in the synthesis sites.

12. The system of paragraph 9, wherein operation of the fluid removal mechanism collects dispensed reagents from the reaction vessels as removed fluid, and wherein the fluid removal mechanism is configured to release at least a portion of the removed fluid while the fluid removal mechanism is removing the dispensed reagents from one or more of the reaction vessels.

13. The system of paragraph 1, wherein the conveyor device produces a current position of each reaction vessel by an amount of movement of the reaction vessel from a starting position in the conveyor device, and wherein the controller is configured to identify the current position based on the amount of movement.

14. The system of paragraph 1, further comprising a robotic transfer device configured to move the reaction vessels automatically to the conveyor device before oligomer synthesis and to remove the reaction vessels automatically from the conveyor device after oligomer synthesis.

15. A system for automated oligomer synthesis, comprising: (A) a synthesis station including a dispenser configured to dispense reagents for oligomer synthesis to reaction vessels disposed in a plurality of synthesis sites of the synthesis station; (B) a conveyor device configured to move the reaction vessels to the plurality of synthesis sites of the synthesis station; and (C) controller configured to receive data defining one or more oligomers for each reaction vessel and to control operation of the dispenser and the conveyor device so that the one or more oligomers for at least one of the reaction vessels is synthesized completely by partial synthesis in each of two or more of the synthesis sites.

16. A method of automated oligomer synthesis, comprising: (A) placing a reaction vessel in each of two or more synthesis sites; and (B) dispensing one or more reagents for synthesis of at least one predefined oligomer to the reaction vessel with the reaction vessel placed in each of the two or more synthesis sites so that the at least one predefined oligomer is synthesized completely by partial synthesis at each of the two or more synthesis sites, wherein the steps of placing and dispensing are performed automatically.

17. The method of paragraph 16, wherein the step of placing includes placing a reaction vessel configured to permit at least a substantial portion of the one or more reagents to pass through the reaction vessel.

18. The method of paragraph 16, wherein the step of placing includes (1) a step of moving the reaction vessel from a first to a second of the two or more synthesis sites, and (2) a step of placing another reaction vessel into the first synthesis site concurrently with the step of moving.

19. The method of paragraph 16, the two or more synthesis sites defining a set of positions to be occupied sequentially by a first reaction vessel and including a last position at which the first reaction vessel can receive the one or more reagents, wherein the step of placing includes a step of moving the first reaction vessel between a pair of the two or more synthesis sites coupled with moving a second reaction vessel beyond the last position, the second reaction vessel including one or more oligomers that are completed.

20. The method of paragraph 16, wherein the step of dispensing includes dispensing one or more nucleic acid components for synthesis of at least one predefined nucleic acid.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

1. A system for automated oligomer synthesis, comprising:
a synthesis station including a dispenser configured to dispense reagents for oligomer synthesis to reaction vessels, the synthesis station having an entrance and an exit;
a conveyor device including a plurality of receivers configured to hold the reaction vessels, the conveyor device being configured to drive the receivers through a closed loop that passes through the synthesis station; and
a controller configured to operate the synthesis station and the conveyor device so that oligomers are synthesized automatically as reaction vessels held by the receivers pass through the synthesis station from the entrance to the exit.

2. The system of claim 1, wherein the dispenser is configured to dispense the reagents to the reaction vessels with the reaction vessels in motion within the synthesis station.

3. The system of claim 1, the reaction vessels being columns having an inlet through which reagents are received and an outlet through which fluid is removed, wherein the conveyor device defines a plurality of discrete holders configured to receive the columns.

4. The system of claim 1, wherein the receivers and their reaction vessels follow a path through the synthesis station, and wherein the synthesis station includes a driver configured to move the dispenser at least substantially horizontally.

5. The system of claim 1, wherein the synthesis station includes a plurality of discrete sub-stations at which individual subunits or subunit multimers of the oligomers are added.

6. The system of claim 1, wherein the synthesis station includes a fluid removal mechanism configured to remove fluid from the reaction vessels, and wherein the fluid removal mechanism includes a plurality of removal mechanisms configured to remove fluid independently from subsets of one or more reaction vessels in the synthesis station.

7. The system of claim 6, wherein the synthesis station includes a driver coupled to the fluid removal mechanism, and wherein the driver is configured to move the fluid removal mechanism along a path parallel to a portion of the closed loop disposed within the synthesis station to selectively engage reaction vessels.

8. The system of claim 1, wherein the conveyor device is configured to have an adjustable speed along the closed loop.

9. The system of claim 1, further comprising a robotic transfer device configured to at least one of (1) add reaction vessels to and (2) remove reaction vessels from the conveyor device.

10. The system of claim 9, wherein the robotic transfer device can remove reaction vessels during their transit through the synthesis station.

11. The system of claim 1, wherein the dispenser is configured to add reagents to the reaction vessels without contacting the reaction vessels.

12. The system of claim 1, the reaction vessels including indicia that permit identification of each reaction vessel, the system further comprising a sensor in communication with the controller and configured to sense the indicia so that the controller can identify each reaction vessel.

13. The system of claim 1, wherein the synthesis station further includes reservoirs that supply the dispenser with reagents for oligomer synthesis, and wherein the reservoirs are configured to be replenished during operation of the dispenser.

14. A system for automated oligomer synthesis, comprising:
a synthesis station including a dispenser configured to dispense reagents for oligomer synthesis to columns, the synthesis station having an entrance and an exit;
a conveyor device including a plurality of re-usable holders configured to support the columns, the conveyor device being configured to drive the holders through a closed loop that passes through the synthesis station; and
a controller configured to receive data defining sequences of subunits of oligomers to be synthesized and to operate the synthesis station and the conveyor device so that the oligomers are synthesized automatically as reaction columns disposed in the holders pass through the synthesis station from the entrance to the exit.

15. A method of automated oligomer synthesis, comprising:
driving a plurality of receivers in a closed loop that passes through a synthesis station including a dispenser configured to dispense reagents for oligomer synthesis to reaction vessels held by the receivers; and
operating the synthesis station and the conveyor device so that the oligomers are synthesized automatically as the reaction vessels pass through the synthesis station.

16. The method of claim 15, further comprising a step of receiving data defining sequences of oligomer products to be synthesized, wherein the step of operating synthesizes oligomers corresponding to the oligomer products based on the data.

17. The method of claim 16, wherein the oligomers have structures that are chemically distinct from the oligomer products, the method further comprising a step of processing the oligomers to create the oligomer products after the step of operating.

18. The method of claim 15, further comprising steps of (1) placing the reaction vessels automatically in the receivers before the reaction vessels pass through the synthesis station, and (2) removing the reaction vessels automatically from the receivers after the reaction vessels pass through the synthesis station.

19. The method of claim 15, wherein the step of operating includes a step of moving a dispenser within the synthesis station in a direction generally parallel to driven movement of the reaction vessels in the synthesis station so that the dispenser can selectively dispense reagents for oligomer synthesis to reaction vessels.

20. The method of claim 15, wherein the step of operating includes a step of removing fluid selectively from a subset of the reaction vessels disposed in the synthesis station.

21. The method of claim 15, wherein the step of driving includes a step of stopping movement of the receivers at a plurality of predefined positions.
